(19) United States
(12) Patent Application Publication
(10) Pub. No.: US 2004/0190539 A1
(43) Pub. Date: Sep. 30, 2004

(54) Communication module outputting a copy of a register of a retimer to a host device

(75) Inventor: Shohei Moriwaki, Hyogo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 10/790,233

(22) Filed: Mar. 2, 2004

(30) Foreign Application Priority Data
Mar. 28, 2003 (JP) 2003-090247(P)

(51) Int. Cl. H04L 12/56

(52) U.S. Cl. 370/419; 370/412

(57) ABSTRACT

A microcomputer stores a copy of an IEEE register having a value updated by an XAUI retimer in an IEEE/XENPAK virtual register in accordance with predetermined timing. In response to a request by a MAC layer, the microcomputer outputs the copy of the IEEE register stored in the IEEE/XENPAK virtual register to the MAC layer via a MDIO interface. Therefore, microcomputer can centrally control the contents of the registers, and can rapidly send the value of the register in response to the request by the MAC layer.

### BACKGROUND OF THE INVENTION

1. Field of the Invention

The present invention relates to a 10-Gb Ethernet (R) communication module such as LX4, and particularly, to a communication module, which centrally controlling or managing a register defined by IEEE (the Institute of Electrical and Electronics Engineers, Inc.) 802.3ae as well as a register defined by 10-Gb Ethernet (R) communication module MSA (Multi-Source Agreement) such as XENPAK (10(X)G EtherNet transceiver PAcKage).

2. Description of the Background Art

In recent years, LAN (Local Area Network) such as Ethernet (R) has been widely used, and 10-Gb Ethernet (R) achieving a higher transfer speed has been actively developed.

In conventional LX4 10-Gb Ethernet (R) communication module, a register defined by IEEE 802.3ae is supported by a retimer chip (XAUI (10X(G) Attachment Unit Interface) retimer) controlling a physical layer. “Introduction to Gibabit Ethernet” (Net Technology Lab., Gijutsu-Hyoron Co., Ltd.) is a technical reference relating to the above. This reference has disclosed a technique, in which a physical layer is divided into a plurality of sublayers PMA (Physical Media Attachment), PCS (Physical Coding Sublayer) and XGXS (10(X)G extension Sublayer), and coding is performed in accordance with respective purposes.

However, the retimer chip described above does not have a MDIO Medium Dependent Input/Output) interface, which is a utility bus required in the 10-Gb Ethernet (R) communication mode. Therefore, a peripheral IC (Integrated Circuit) for MDIO interface must be additionally employed, which increases a footprint and a cost of the ICs.

### SUMMARY OF THE INVENTION

An object of the invention is to provide a communication module achieving a register access environment, which is centralized with respect to register access from a host device.

According to an aspect of the invention, a communication module for use in Fast Ethernet (R) includes a retimer for controlling a physical layer; and a microcomputer for performing general control of the communication module. The microcomputer includes a storing portion storing a copy of a register having a value updated by the retimer in accordance with predetermined timing, and an input/output portion outputting the copy of the register stored in the storing portion to a host device in accordance with a request by the host device.

Since the storing portion in the microcomputer stores the copy of the register having the value updated by the retimer, the microcomputer can perform the centralized control of the contents of the registers so that it can rapidly send the values of the registers in response to the request by the host device.

According to another aspect of the invention, a communication module for use in Fast Ethernet (R) includes a retimer for controlling a physical layer; and first and second microcomputers for performing general control of the communication module. The first microcomputer includes a first storing portion storing a copy of a register having a value updated by the retimer in accordance with predetermined timing, and a first input/output portion outputting the copy of the register stored in the first storing portion to a host device in accordance with a request by the host device. The second microcomputer includes a second storing portion storing contents of a register defined by 10-Gb Ethernet (R) communication module multi-source agreement, and a second input/output portion outputting the contents stored in the second storing portion to the host device in accordance with a request by the host device.

The first storing portion in the first microcomputer stores the copy of the register having the value updated by the retimer, and the second storing portion in the second microcomputer stores the contents of the register defined by the 10-Gb Ethernet (R) communication module multi-source agreement. Therefore, the microcomputers can centrally control or manage the contents of the registers so that the values of the registers can be sent fast in response to the request by the host device, and processing loads imposed on the first and second microcomputers can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic structure of a communication system including a communication module of a first embodiment of the invention.

FIG. 2 illustrates, by way of example, contents of an IEEE register and a XENPAK register of the first embodiment of the invention.

FIG. 3 is a block diagram showing a schematic structure of a communication system including a communication module of a second embodiment of the invention.

FIGS. 4A and 4B illustrate, by way of examples, contents of an IEEE register and a XENPAK register of the second embodiment of the invention.

### DESCRIPTION OF THE PREFERRED EMBODIMENTS

(First Embodiment)

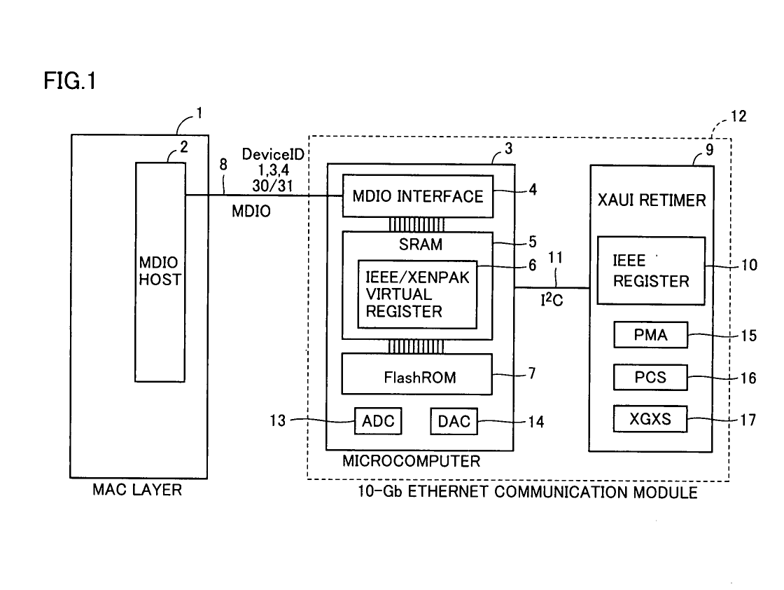

FIG. 1 is a block diagram showing a schematic structure of a communication system including a 10-Gb Ethernet (R) communication module, which will be merely referred to as a “communication module” hereinafter, according to a first embodiment of the invention. This communication system includes a communication module 12 and a MAC layer 1 centrally controlling or managing communication module 12. Although FIG. 1 shows only one communication module, the communication system includes a plurality of communication modules having similar structures, and MAC layer 1 centrally control these communication modules.

MAC layer 1 includes a MDIO host 2 controlling communication module 12 through a serial bus (MDIO bus) 8.

Communication module 12 includes a microcomputer 3 performing general control of communication module 12 connected to MAC layer 1, and XAUI retimer 9 controlling a physical layer of the communication in communication module 12. Microcomputer 3 and XAUI retimer 9 are connected via an I²C (Internal Institute for Communications) bus 11 for data transmission.

XAUI retimer 9 includes function blocks of PMA 15, PCS 16 and XGXS 17. These function blocks 15, 16 and 17 have registers defined by IEEE 802.3ae, and these registers are collectively referred to as an IEEE register 10 hereinafter.

Microcomputer 3 includes a MDIO interface 4 connected to MDIO host 2 in MAC layer 1, a SRAM (Static Random Access Memory) 5 and a flash ROM (Read Only Memory) 7. SRAM 5 includes an IEEE/XENPAK virtual register 6 holding contents of IEEE register 10 and contents of a register, which is defined by XENPAK and will be referred to as a XENPAK register hereinafter. Flash ROM 7 stores programs to be executed by microcomputer 3, initial values of the IEEE register and XENPAK register, and others. SRAM 5 may be a fast storage medium allowing random access. Flash ROM 7 may be another nonvolatile memory, which can hold data even after communication module 12 is powered off.

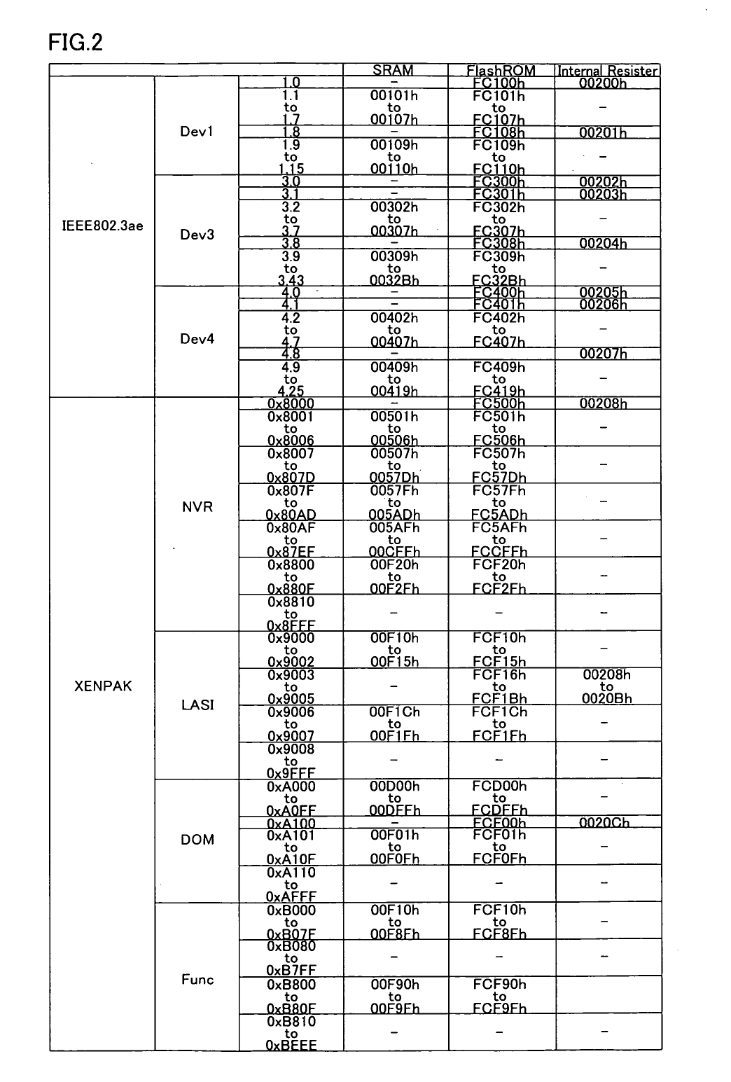

FIG. 2 illustrates, by way of example, contents of the IEEE register and XENPAK register in the first embodiment of the invention. In an order from left to right, FIG. 2 illustrates registers defined by IEEE 802.3ae and XENPAK, IEEE/XENPAK virtual register 6 developed on SRAM 5, the flash ROM, and registers, which are achieved by hardware due to restrictions on function, among the registers defined by IEEE 802.3ae and XENPAK.

The registers defined by IEEE 802.3ae include registers of device 1 (PCS), registers of device 3 (PMA) and registers of device 4 (XGXS). For example, registers 1.1-1.7 of device 1 are mapped to addresses 00101h-00107h of SRAM 5, and are mapped to addresses FC101h-FC107h of flash ROM 7, respectively.

Registers defined by XENPAK include NVRs (Non-Volatile Registers), LASI (Link Alarm Status Interrupt) registers, DOM (Digital Optical Monitoring) registers and Function registers. For example, 0×8001-0×8006 of the NVRs are mapped to addresses 00501h-00506h of SRAM 5, and are mapped to addresses FC501h-FC506h of flash ROM 7, respectively.

When communication module 12 starts operating, microcomputer 3 reads initial values of the IEEE register from flash ROM 7, and loads them to IEEE register 10 through I²C bus 11. When communication module 12 operates, XAUI retimer 9 updates the contents of IEEE register 10. Therefore, microcomputer 3 reads the contents of IEEE register 10 through I²C bus 11 at regular intervals or in accordance with appropriate timing, and develops them on IEEE/XENPAK virtual register 6.

Microcomputer 3 controls peripheral functions, e.g., of an ADC (Analog-to-Digital Converter) 13 and a DAC (Digital-to-Analog Converter) 14, which are contained in microcomputer 3, to achieve the DOM function determined by XENPAK, and stores results thereof in IEEE/XENPAK virtual register 6.

When MDIO host 2 in MAC layer 1 issues a register access request via MDIO interface 4, microcomputer 3 reads contents of IEEE/XENPAK virtual register 6 in response to the device ID (1, 3, 4, 30/31) designed by MDIO host 2, and sends them to MDIO host 2 via MDIO interface 4. Device ID 30/31 indicates the register defined by XENPAK.

For returning the contents of register in response to the request by MAC layer 1, it is necessary to provide a structure achieving a response speed defined by MDIO interface standards, which are defined by IEEE 802.3ae. In this embodiment, microcomputer 3 reads the contents of IEEE/XENPAK virtual register 6 in response to the register access request made by MAC layer 1, and returns them to MAC layer 1 so that the contents of the register can be returned to MAC layer 1 within a turn-around time.

Further, microcomputer 3 writes the contents of IEEE/XENPAK virtual register 6 into a region, which stores initial values of the IEEE/XENPAK register at regular intervals or in accordance with appropriate timing.

According to the communication module of the first embodiment, as described above, IEEE/XENPAK virtual register 6 holds the contents of IEEE register and XENPAK register, and the contents of IEEE/XENPAK virtual register 6 are returned to MAC layer 1 in response to the request by MAC layer 1. Therefore, it is possible to provide the centralized register access environment with respect to the register access made by MAC layer 1.

Due to constraints of a turn-around time, a conventional communication module is formed of dedicated FPGA (Field Programmable Gate Array), ASIC (Application Specific Integrated Circuit), EEPROM (Electrically Erasable and Programmable Read Only Memory), DOM controller and others. In contrast to this, the contents of the register can be returned to MAC layer 1 within the turn-around time, while using microcomputer 3. Therefore, microcomputer 3 can achieve the structures except for XAUI retimer 9 so that a footprint and a cost of the devices arranged in communication module 12 can be significantly reduced.

In 10-Gb Ethernet (R) communication modules other than LX4, registers defined by IEEE 802.3an and registers defined by 10-Gb Ethernet (R) communication module MSA such as XENPAK are supported by a PHY chip controlling a physical layer, and therefore, it is necessary to change a design of the PHY chip if specifications or the like are changed. In this embodiment, however, microcomputer 3 holds the contents of the respective registers in IEEE/XENPAK virtual register 6. Therefore, it is possible to deal with changes in specifications within a short time by adding registers stored in IEEE/XENPAK virtual register 6 and/or changing the programs.

Further, microcomputer 3 writes the contents of IEEE/XENPAK virtual register 6 in the region storing the initial values of IEEE/XENPAK virtual register 6 of flash ROM 7 at regular intervals or in accordance with appropriate timing. Therefore, initial data of the respective registers can be easily updated and backed up.

(Second Embodiment)

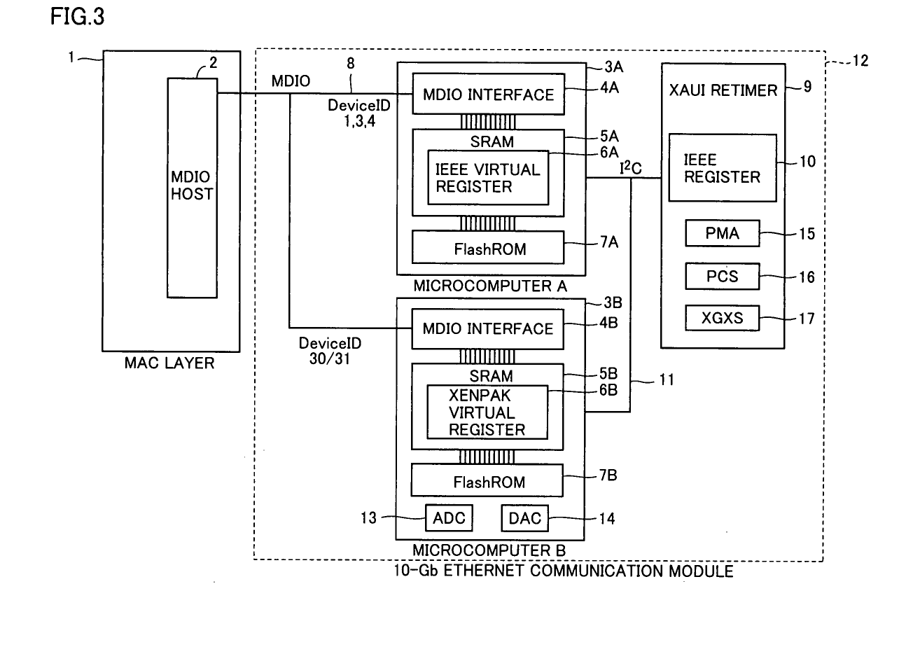

FIG. 3 is a block diagram showing a schematic structure of a communication system including a communication module of a second embodiment of the invention. This differs from the communication module of the first embodiment shown in FIG. 1 in that two microcomputers 3 are employed. In this embodiment, the two microcomputers are indicated by reference numbers 3A and 3B, respectively.

Microcomputer 3A includes a MDIO interface 4A connected to MDIO host 2 in MAC layer 1, an SRAM 5A and a flash ROM 7A. SRAM 5A includes an IEEE virtual register 6A holding contents of IEEE register 10. Flash ROM 7A stores programs to be executed by microcomputer 3A and initial values of the IEEE register and others. SRAM 5A may be another fast storage medium allowing random access, and flash ROM 7A may be another nonvolatile memory, which can hold data even after communication module 12 is powered off.

Microcomputer 3B executes the programs to achieve functions defined by XENPAK, and includes a MDIO interface 4B connected to MDIO host 2 in MAC layer 1, a SRAM 5B and a flash ROM 7B. SRAM 5B includes a XENPAK virtual register 6B holding contents of the registers defined by XENPAK. Flash ROM 7B stores programs to be executed by microcomputer 3B and initial values of the XENPAK register. SRAM 5B may be another fast storage medium allowing random access, and flash ROM 7B may be another nonvolatile memory, which can hold data even after communication module 12 is powered off.

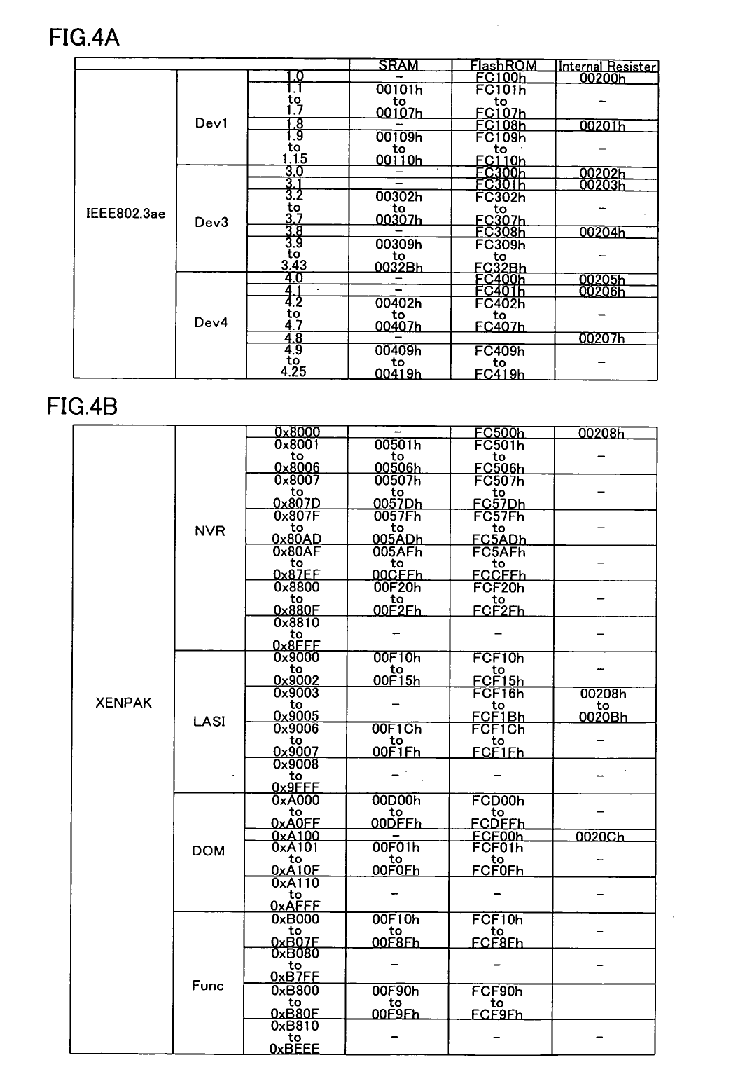

FIGS. 4A and 4B illustrate, by way of example, contents of the IEEE register and XENPAK register of the second embodiment. In an order from left to right, FIGS. 4A and 4B illustrate registers defined by IEEE 802.3ae and XENPAK, IEEE virtual register 6A or XENPAK virtual register 6B developed on SRAM 5A or 5B, and registers, which are achieved by hardware due to restrictions on function, among the registers defined by flash ROM 7A or 7B, and IEEE 802.3ae or XENPAK.

As illustrated in FIG. 4A, registers defined by IEEE 802.3ae include registers of device 1 (PCS), registers of device 3 (PMA) and registers of device 4 (XGXS). For example, registers 1.1-1.7 of device 1 are mapped to addresses 00101h-00107h of SRAM 5, and are mapped to addresses FC101h-FC107h of flash ROM 7, respectively.

As illustrated in FIG. 4B, registers defined by XENPAK include NVRs, LASI registers, DOM registers and Function registers. For example, 0×8001-0×8006 of the NVRs are mapped to addresses 00501h-00506h of SRAM 5, and are mapped to addresses FC501h-FC506h of flash ROM 7, respectively.

When communication module 12 starts operating, microcomputer 3A reads initial values of the IEEE register from flash ROM 7A, and loads them to IEEE register 10 through I²C bus 11. When communication module 12 operates, XAUI retimer 9 updates the contents of IEEE register 10. Therefore, microcomputer 3A reads the contents of IEEE register 10 through I²C bus 11 at regular intervals or in accordance with appropriate timing, and develops them on IEEE virtual register 6A.

Microcomputer 3B controls peripheral functions, e.g., of the ADC 13 and DAC 14, which are contained in microcomputer 3B, achieves the DOM function determined by XENPAK, and stores results thereof in XENPAK virtual register 6B. Likewise, microcomputer 3B executes the programs to achieve the NVR function, LASI function and others determined by XENPAK, and stores results thereof in XENPAK virtual register 6B.

When MDIO host 2 in MAC layer 1 issues a register access request via MDIO interface 4, microcomputer 3A or 3B reads contents of IEEE virtual register 6A or XENPAK virtual register 6B in response to the device ID (1, 3, 4, 30/31) designed by MDIO host 2, and sends them to MDIO host 2 via MDIO interface 4A or 4B.

Further, microcomputers 3A and 3B write the contents of IEEE virtual register 6A and XENPAK virtual register 6B into a region, which stores initial values of the IEEE or XENPAK register of flash ROM 7A or 7B at regular intervals or in accordance with appropriate timing.

As described above, the communication module of this embodiment can achieve the same effects as those of the first embodiment. Further, microcomputers 3A and 3B control the contents of IEEE virtual register 6A and XENPAK virtual register 6B, respectively, so that the processing loads of them can be reduced. This allows further fine monitoring, control and management in the communication module.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication module used in Fast Ethernet (R) comprising:
a retimer controlling a physical layer; and
a microcomputer performing general control of said communication module, wherein
said microcomputer includes:
a storing portion storing a copy of a register having a value updated by said retimer in accordance with predetermined timing, and
an input/output portion outputting the copy of the register stored in said storing portion to a host device in accordance with a request by said host device.

2. The communication module according to claim 1, wherein
said storing portion further stores contents of a register defined by 10-Gb Ethernet (R) communication module multi-source agreement.

3. The communication module according to claim 1, wherein
said microcomputer further includes a nonvolatile memory in which the copy of the register stored in said storing portion is written in accordance with predetermined timing.

4. A communication module for use in Fast Ethernet (R) comprising:
a retimer for controlling a physical layer; and
first and second microcomputers performing general control of said communication module, wherein
said first microcomputer includes:
a first storing portion storing a copy of a register having a value updated by said retimer in accordance with predetermined timing, and
a first input/output portion outputting the copy of the register stored in said first storing portion to a host device in accordance with a request by said host device; and
said second microcomputer includes:
a second storing portion storing contents of a register defined by 10-Gb Ethernet (R) communication module multi-source agreement, and
a second input/output portion outputting the contents stored in said second storing portion to said host device in accordance with a request by said host device.

5. The communication module according to claim 4, wherein
said first microcomputer further includes a first nonvolatile memory in which the copy of the register stored in said first storing portion is written in accordance with predetermined timing.

6. The communication module according to claim 4, wherein
said second microcomputer further includes a second nonvolatile memory in which the contents stored in said second storing portion are written in accordance with predetermined timing.
